(19) United States
(12) Patent Application Publication
(10) Pub. No.: US 2009/0147183 A1
(43) Pub. Date: Jun. 11, 2009

(54) BACKLIGHT UNIT AND FLAT PANEL DISPLAY HAVING THE BACKLIGHT UNIT

(75) Inventors: Dae Hyoun BYOUN, Seoul, Korea (KR); Jun Seok AN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/208,745

(22) Filed: Sep. 11, 2008

(30) Foreign Application Priority Data
Dec. 7, 2007 (KR) 2007-127120

(51) Int. Cl. G02F 1/1335; F21V 7/00

(52) U.S. Cl. 349/67; 362/307

(57) ABSTRACT

A flat panel display having an LCD panel, a light source to emit light, and a reflection plate including a reflection part to reflect the light emitted from the light source and a light guide part to guide the light emitted from the light source toward the LCD panel, which are integrally formed with each other. The reflection plate may be a double injection molded object in which the reflection part and the light guide part are integrally formed.

### CROSS-REFERENCE TO RELATED APPLICATIONS

This application claims priority under 35 U.S.C. § 119(a) from Korean Patent Application No. 2007-127120, filed on Dec. 7, 2007, in the Korean Intellectual Property Office, the disclosure of which is incorporated herein by reference.

### BACKGROUND OF THE INVENTION

1. Field of the Invention

The present general inventive concept relates to a flat panel display, and more particularly to a backlight unit improved to save the number of parts and a flat panel display having the backlight unit, and method of manufacturing the same.

2. Description of the Related Art

Generally, a flat panel display is classified as an emissive display or a non-emissive display. The emissive display, which actively emits light, includes a cathode-ray tube (CRT), a plasma display panel (PDP) and so on. The non-emissive display cannot actively emit light. A liquid crystal display (LCD) is a representative example of the non-emissive display.

The non-emissive flat panel display is able to display an image by receiving light from the outside. Owing to this characteristic, the non-emissive flat panel display needs a backlight unit, besides a display panel, to emit light to the display panel.

The backlight unit is divided into a direct light type and an edge light type according to a mounting position of a light source thereof. In the direct light type, the light source is disposed at a rear side of the display panel, thereby emitting light directly toward the display panel. The light source of the edge light type is disposed at lateral edges of a light guide panel to emit the light toward the display panel through the light guide panel. The light source used for the backlight unit includes a linear light source and a point light source. A cold cathode fluorescent lamp (CCFL) is a typical linear light source. A light emitting diode (LED) is a typical point light source.

FIG. 1A and FIG. 1B are sectional views schematically illustrating part of a conventional backlight unit of the edge light type.

As illustrated in FIG. 1A and FIG. 1B, a conventional edge-light-type backlight unit 10 disposed at a rear side of a display panel 1 comprises a base chassis 11, a light source 12 mounted to an upper part of the base chassis 11, and a light guide panel 15 guiding light generated from the light source 12 toward the display panel 1. The light source 12 comprises a pair of lamps 13 generating the light, and a lamp holder 14 supporting the lamps 13 in connection with the base chassis 11. Additionally, a reflection sheet 16 is attached to a rear side and lateral sides of the light guide panel 15 so that most of the light is emitted toward the rear side of the display panel 1 under guidance of the light guide panel 15.

FIG. 2 is a sectional view schematically illustrating another conventional edge-light-type backlight unit.

Referring to FIG. 2, a conventional backlight unit 20 comprises a base chassis 21, a light source 22 mounted to an upper part of the base chassis 21, a light guide panel 23 guiding light generated from the light source 22 toward the display panel 1, and a light source cover 24 fixing the light source 22 onto the base chassis 21. In addition, a reflection sheet 25 is mounted to an inside of the light source cover 24 so as to reflect the light of the light source 22 toward the light guide panel 23. Furthermore, a reflection sheet 26 is mounted to a rear surface of the light guide panel 23 to reflect the light being guided by the light guide panel 23 toward the display panel 1.

However, those conventional backlight units include a number of component parts, that is, the base chassis, the light guide panel, the reflection sheet and the light source cover which are to be assembled after being separately manufactured. Also, connection units are required to assemble the parts, thereby complicating the assembling work. Accordingly, the manufacturing cost and time increase.

### SUMMARY OF THE INVENTION

The present general inventive concept addresses one or more of the above problems with the related art. The present general inventive concept provides a backlight unit capable of saving the manufacturing cost and time by simplifying the structure thereof and reducing the number of parts, and a flat panel display having the same. The present general inventive concept also provides a method of manufacturing the backlight unit and the display unit having the same.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a flat panel display, the display including a front cover having a first surface and a second surface, a liquid crystal display (LCD) panel disposed at the rear of the front cover, a light source emitting light, a reflection plate having a first surface and a second surface, the reflection plate including a reflection part to reflect the light emitted from the light source and a light guide part to guide the light emitted from the light source toward the LCD panel, which are integrally formed with each other, such that the light source is disposed at a first side surface of the light guide part, and a rear cover disposed at the second surface of the reflection plate.

The reflection plate may be a double injection molded object in which the reflection part and the light guide part are integrally formed.

The reflection plate may include a reflective resin and a light-transmissive resin.

The material for the reflection part is a compound of polycarbonate and 10-20% of glass fiber.

The reflection part may include at least one sidewall extended from a first surface of the reflection part, and the light source is disposed between the at least one sidewall and the first side surface of the light guide part.

The at least one sidewall may include a sidewall contacting a second side surface of the light guide part.

The reflection part may include a reflection pattern to reflect the light emitted from the light source toward the LCD panel.

The light guide part may include a reflection pattern to reflect the light emitted from the light source toward the LCD panel.

The thickness of the light guide part may decrease in a direction of being distanced from the light source such that a second surface of the light guide part that contacts the reflection part is depressed toward a first surface of the light guide part, and the reflection part is curved to contact the second surface of the light guide part.

The flat panel display may further include a reflection sheet which covers an opened part formed between the sidewall of the reflection part and the first side surface of the light guide part.

The foregoing and/or other aspects and utilities of the general inventive concept may also be achieved by providing a backlight unit including a light source emitting light, and a reflection plate including a reflection part to reflect the light emitted from the light source and a light guide part to guide the light reflected from the reflection part, which are integrally formed with each other.

The foregoing and/or other aspects and utilities of the general inventive concept may also be achieved by providing a display including a panel, a light source to emit light, a light guide plate to guide the light toward the panel, a front cover, and a rear cover coupled to the front cover, to form a first space to accommodate the panel, a second space to accommodate the light source, and a third space to accommodate the light guide plate, and having a reflection part to reflect light toward the panel through the light guide plate, where the reflection part is formed with the rear cover in a single monolithic body.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1A, FIG. 1B and FIG. 2 are sectional views schematically illustrating conventional backlight units;

FIG. 3 is a perspective view schematically illustrating a flat panel display according to an embodiment of the present general inventive concept;

FIG. 4A and FIG. 4B illustrate schematic sectional views of the flat panel display of FIG. 3;

FIG. 5A and FIG. 5B illustrate enlarged views of a portion “A” of FIG. 4A; and

FIG. 6 to FIG. 8 are sectional views each illustrating a backlight unit according to various embodiments of the present general inventive concept.

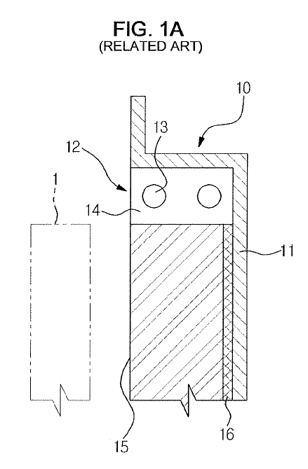

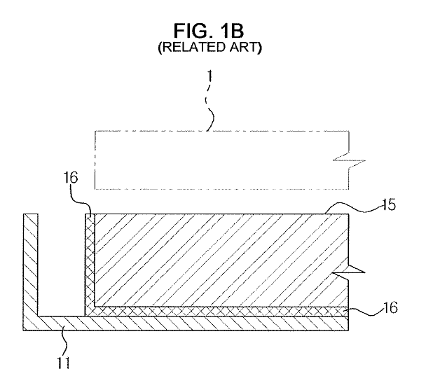

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

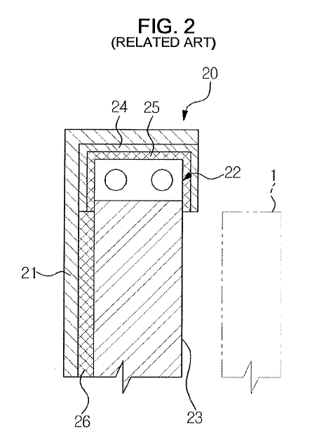

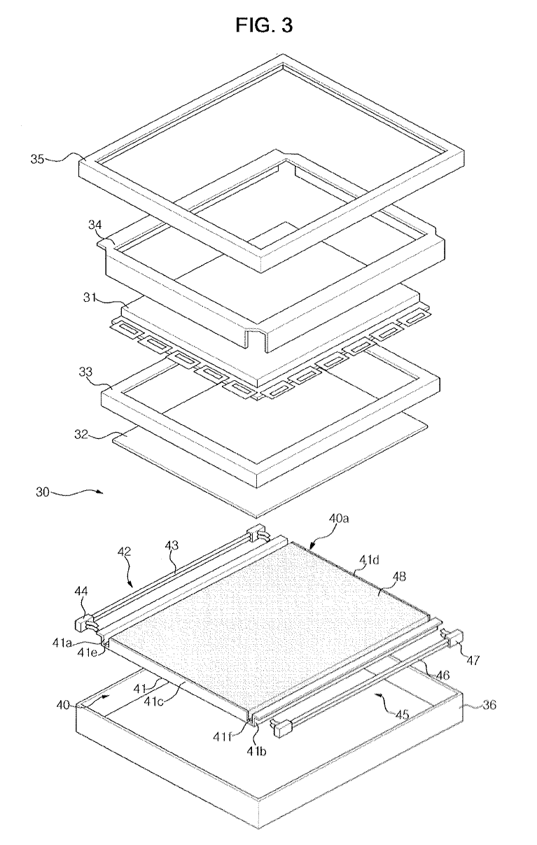

As illustrated in FIG. 3, a flat panel display 30 includes an LCD panel 31 to display an image, a backlight unit 40 to emit light to the LCD panel 31, an optical sheet 32 mounted between the LCD panel 31 and the backlight unit 40, a frame 33 to connect the optical sheet 32 to the backlight unit 40, and a top chassis 34 to connect the LCD panel 31 to the backlight unit 40. As illustrated in the drawing, the optical sheet 32 mounted between the LCD panel 31 and the backlight unit 40 may be a single optical sheet or a plurality of sheets.

A front cover 35 is disposed on a first side (e.g., a front side) of the top chassis 34. A rear cover 36 may be disposed behind the backlight unit 40 (e.g., adjacent to surface S2) to be connected with the front cover 35.

The LCD panel 31 displays the image by receiving an image signal from the outside. Since the structure and the operation principle of the LCD panel 31 are generally known in the art, detailed description thereof will be omitted. Instead of the LCD panel 31 displaying the image, the flat panel display 30 according to an embodiment of the present general inventive concept may adopt a transparent or translucent panel to display an image.

The backlight unit 40 comprises a reflection plate 40a having a reflection part 41 and a light guide part 48, and first and second light sources 42 and 45 each generating light. A first light source 42 may include one or more lamps 43 to generate light, and a lamp holder 44 to support the one or more lamps 43 in connection with the reflection part 41 and the light guide part 48. A second light source 45 may include one or more lamps 46 to generate light, and a lamp holder 47 to support the one or more lamps 46 in connection with reflection part 41 and the light guide part 48.

The reflection part 41 reflects the light emitted from the first and second light sources 42 and 45. The light guide part 48 guides the light reflected from the reflection part 41 toward the LCD panel 31. In addition, a circuit board to drive the flat panel display 30 may be mounted to a rear surface of the reflection plate 40a.

The reflection part 41 has a square casing form comprising four sidewalls 41a, 41b, 41c and 41d. First and second mounting grooves 41e and 41f each to mount the first and second light sources 42 and 45 therein are formed at upper and lower parts of the reflection part 41, respectively. The reflection part 41 is formed of resin, by double injection molding to be integrally formed with the light guide part 48. More specifically, since the resin forming the reflection part 41 has reflectivity, an inner surface of the reflection part 41 constitutes a reflection surface. The reflection part 41 may also be formed with the rear cover 36 in a single monolithic body.

As the resin has a higher reflectivity, brightness of the light emitted toward the LCD panel 31 through the light guide part 48 (e.g., of surface S1) is increased. Therefore, the reflection part 41 preferably has a bright color, such as white. Polycarbonate (PC) is one material that may be used for the bright-colored resin. However, any other resin may be selected for the reflection part 41.

In this embodiment, the reflection part 41 is made of a compound of the PC and 10-20% of glass fiber. If the compound of the PC and 10-20% of glass fiber is used for the material of the reflection part 41, while reflectivity of the reflection part 41 is maintained over a predetermined degree, strength of the reflection part 41 can be increased whereas thermal expansion rate can be reduced. Therefore, deformation of the reflection part 41 caused by an external force or heat generated from the lamps 53 can be considerably reduced.

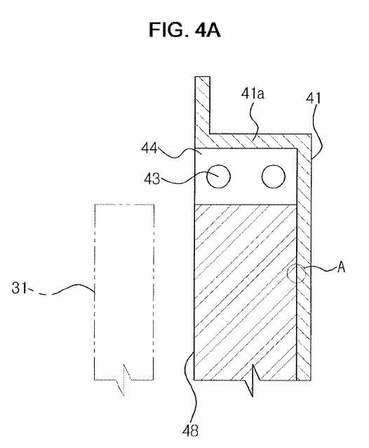

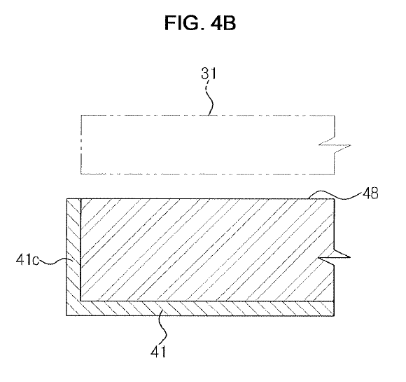

As illustrated in FIG. 4A, upper and lower sidewalls 41a and 41b are among the four sidewalls 41a, 41b, 41c, and 41d that cover an outer surface of the first and second light sources 42 and 45 such that part of the light from the light sources 42 and 45, emitting oppositely to the light guide part 48, can be reflected toward the light guide part 48 by the upper and lower sidewalls 41a and 41b.

As illustrated in FIG. 4B, left and right sidewalls 41c and 41d among the four sidewalls 41a, 41b, 41c, and 41d that cover left and right sides of the light guide part 48, which do not contact the respective light sources 42 and 45, so as to minimize and/or prevent the light incident to the light guide part 48 from the light sources 42 and 45 from emitting outward through the left and right sides (e.g., the sides of sidewalls 41c and 41d, respectively) of the light guide part 48. The four sidewalls 41a, 41b, 41c, and 41d thus restrain loss of the light generated from the first and second light sources 42 and 45, thereby increasing luminosity of the light emitted toward the LCD panel 31.

The light guide part 48 that guides the light of the first and second light sources 42 and 45 toward the LCD panel 31 is formed of a transparent resin, being integrally formed with the reflection part 41 by double injection molding. The order between the light guide part 48 and the reflection part 41 in the double injection molding does not matter. In other words, the light guide part 48 may be injection-molded later after injection-molding the reflection part 41, and vice versa.

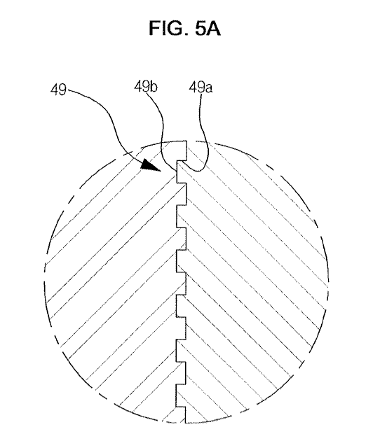

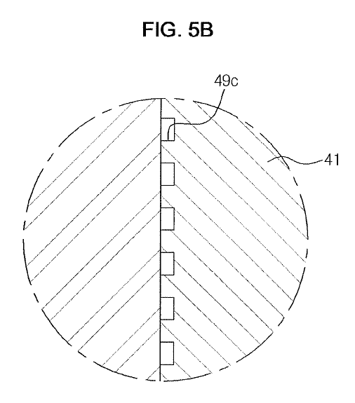

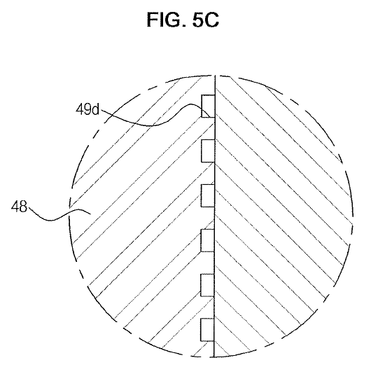

FIG. 5A through to FIG. 5C are enlarged views of a portion “A” of FIG. 4A.

As illustrated in FIG. 5A, a plurality of reflection patterns 49 are formed at a rear surface (e.g., surface S2 illustrated in FIG. 3) of the light guide part 48, which is in contact with the reflection part 41, to emit the light incident to the light guide part 48 toward the front (e.g., surface S1 illustrated in FIG. 3) of the light guide part 48. In general structures where the light guide part 48 and the reflection part 41 are separately formed, the reflection patterns 49 are printed on the rear surface of the light guide part 48. However, in the present embodiment where the light guide part 48 is integrally formed with the reflection part 41, printing of the reflection patterns 49 is difficult. Therefore, the reflection patterns 49 are formed as an uneven surface on the rear surface of the light guide part 48. The reflection patterns 49 comprises a plurality of pattern grooves 49a formed on the rear surface of the light guide part 48, and a plurality of pattern projections 49b formed on a front surface of the reflection part 41 to be inserted in the pattern grooves 49a. Since the reflection part 41 is formed by the reflective resin, the pattern projections 49b of the reflection part 41, projecting through the pattern grooves 49a, are capable of reflecting the light incident into the light guide part 48 toward the LCD panel 31.

However, the reflection patterns 49 do not need to be on both the reflection part 41 and the light guide part 48. For example, just the front surface of the light guide part 48 includes reflection patterns 49c as illustrated in FIG. 5B, or just the rear surface of the light guide part 48 may include reflection patterns 49d as illustrated in FIG. 5C.

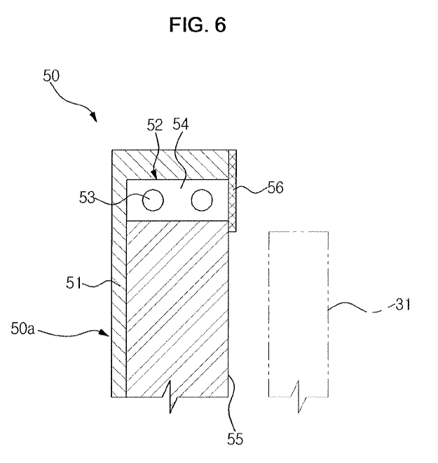

FIG. 6 through FIG. 8 illustrate a backlight unit according to embodiments of the present general inventive concept.

A backlight unit 50 illustrated in FIG. 6 comprises a reflection plate 50a having a reflection part 51, a light source 52 connected to the reflection plate 50a, a light guide part 55 integrally formed with the reflection part 51 by double injection molding to guide light generated from the light source 52, and a reflection sheet 56 covering an opened part of the light source 52. The light source 52 comprises a pair of lamps 53 generating light, and a lamp holder 54 supporting the lamps 53. The reflection part 51, the light source 52 and the light guide part 55 are similar to those of the backlight unit 40 according to an embodiment of the present general inventive concept.

The reflection sheet 56 covers an exposed part of the light source 52 not covered with the light guide part 55, such that the light emitting beyond the light guide part 55 can be reflected toward the light guide part 55. By the operation of the reflection sheet 56, luminosity of the light incident to the light guide part 55 and the light emitted to the LCD panel 31 through the light guide part 55 can be increased.

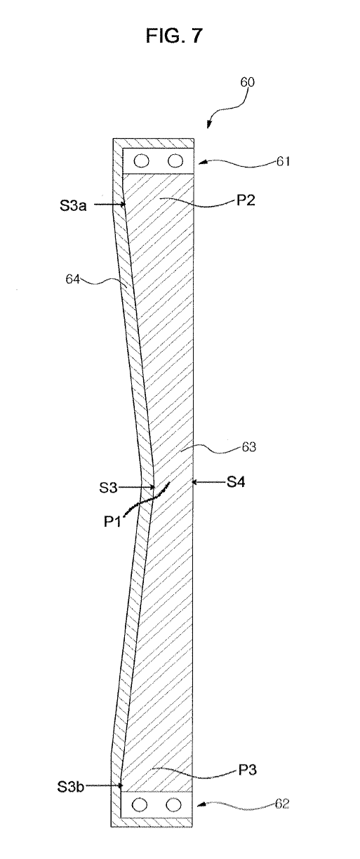

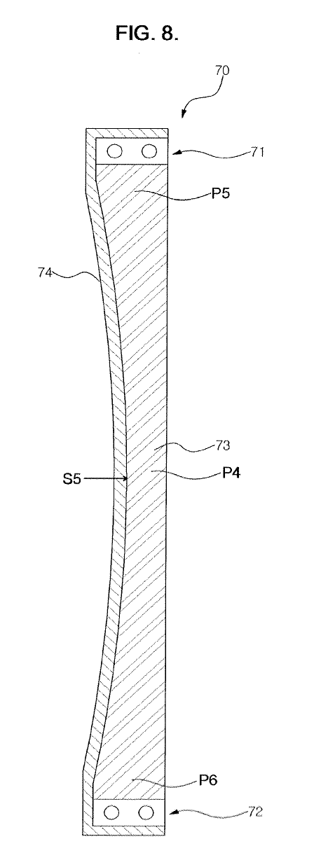

FIG. 7 and FIG. 8 each illustrate a backlight unit having a smaller light guide part.

In a backlight unit 60 illustrated in FIG. 7, a first light source 61 and a second light source 62 are mounted on both sides of a light guide part 63 to face each other. The thickness of the light guide part 63 gradually decreases in a direction of being distanced from the light sources 61 and 62. A rear surface S3 of the light guide part 63 is depressed toward a front (i.e., towards surface S4) of the light guide part 63 while the front surface S4 of the light guide part 63 is flat. An upper rear surface S3a of the light guide part 63 near the first light source 61 is sloped by a predetermined angle toward the middle part (P1) of the light guide part 63. A lower rear surface (S3b) of the light guide part 63 near the second light source 62 is also sloped by a predetermined angle toward the middle part (P1). Accordingly, the both ends (P2 and P3) of the light guide part 63 near the respective light sources 61 and 62 are thickest while the middle part (P1) at the same distance from the both light sources 61 and 62 is thinnest.

A reflection part 64 is curved at the middle part (P1) thereof toward the front (S4) of the light guide part 63 so that the middle part (P1) contacts the depressed rear surface (S3) of the light guide part 63.

Similarly with the backlight unit 60 of FIG. 7, a backlight unit 70 illustrated in FIG. 8 includes first and second light sources 71 and 72 mounted on both sides of a light guide part 73 to face each other. Also, the thickness of the light guide part 73 gradually decreases in a direction of being distanced from the both light sources 71 and 72. However, the rear surface (S5) of the light guide part 73 is curvedly depressed whereas the depressed rear surface (S3) of the light guide part 63 comprises flat surfaces. Both ends (P5 and P6) of the light guide part 73 near the respectively light sources 71 and 72 are thickest while the middle part (P4) is thinnest. A reflection part 74 has a curve form for contact with the rear surface (S5) of the light guide part 73, which is depressed.

By thus decreasing the volume of the light guide parts 63 and 73, the backlight units 60 and 70 illustrated in FIGS. 7 and 8 can reduce the material cost and the manufacturing cost.

As can be appreciated from the above description of the flat panel display according to the embodiments of the present general inventive concept, since the light guide part and the reflection part are integrally formed by double injection molding, the number of parts is reduced, accordingly saving the manufacturing cost and time.

Although the flat panel display having the LCD panel to display an image has been explained concerning according to the embodiment, the flat panel display according to the present general inventive concept may include a transparent panel or translucent panel printed with pictures, such that the flat panel display of the present general inventive concept is also applicable to an LCD device or an advertisement board.

In addition, although the backlight unit according to the various embodiments of the present general inventive concept includes lamps as a linear light source, a point light source may be adopted instead of the linear light source.

According to the above description, in the flat panel display according to an embodiment of the present general inventive concept, a reflection sheet can be omitted since an inner surface of a reflection plate comprises a reflection surface. Accordingly, the number of parts can be reduced while the structure is simplified.

Furthermore, according to an embodiment of the present general inventive concept, since a reflection part and a light guide part of the flat panel display are integrally formed with each other by double injection molding, manufacturing time can be saved.

Although embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. A flat panel display comprising:
a front cover;
a liquid crystal display (LCD) panel disposed at the rear of the front cover;
a light source emitting light;
a reflection plate including a reflection part to reflect the light emitted from the light source and a light guide part to guide the light emitted from the light source toward the LCD panel, which are integrally formed with each other, such that the light source is disposed at a first side surface of the light guide part; and
a rear cover disposed at the rear of the reflection plate.

2. The flat panel display of claim 1, wherein the reflection plate is a double injection molded object in which the reflection part and the light guide part are integrally formed.

3. The flat panel display of claim 2, wherein the reflection plate comprises a reflective resin and a light-transmissive resin.

4. The flat panel display of claim 2, wherein the material for the reflection part is a compound of polycarbonate and 10-20% of glass fiber.

5. The flat panel display of claim 3, further comprising:
a reflection sheet which covers an opened part formed between the sidewall of the reflection part and the first side surface of the light guide part.

6. The flat panel display of claim 1, wherein the reflection part comprises at least one sidewall extended from a front thereof, and the light source is disposed between the at least one sidewall and the first side surface of the light guide part.

7. The flat panel display of claim 6, wherein the at least one sidewall includes a sidewall contacting a second side surface of the light guide part.

8. The flat panel display of claim 1, wherein the reflection part comprises a reflection pattern to reflect the light emitted from the light source toward the LCD panel.

9. The flat panel display of claim 1, wherein the light guide part comprises a reflection pattern to reflect the light emitted from the light source toward the LCD panel.

10. The flat panel display of claim 1, wherein the thickness of the light guide part decreases in a direction of being distanced from the light source such that a rear surface of the light guide part that contacts the reflection part is depressed toward a front of the light guide part, and the reflection part is curved to contact the rear surface of the light guide part.

11. A backlight unit comprising:
a light source emitting light; and
a reflection plate including a reflection part to reflect the light emitted from the light source and a light guide part to guide the light reflected from the reflection part, which are integrally formed with each other.

12. The backlight unit of claim 11, wherein the reflection plate is a double injection molded object in which the reflection part and the light guide part are integrally formed.

13. The backlight unit of claim 12, wherein the reflection plate comprises a reflective resin and a light-transmissive resin.

14. The backlight unit of claim 12, wherein the material for the reflection part is a compound of polycarbonate and 10-20% of glass fiber.

15. The backlight unit of claim 11, wherein the reflection part includes a sidewall disposed at the outside of the light source, and the light source is disposed between the sidewall and a first side surface of the light guide part.

16. The backlight unit of claim 11, wherein the reflection part comprises a sidewall that contacts a second side surface of the light guide part.

17. The backlight unit of claim 11, wherein at least one of the reflection part and the light guide part includes a reflection pattern to reflect the light emitted from the light source toward a front of the light guide part.

18. The backlight unit of claim 11, wherein the thickness of the light guide part decreases in a direction of being distanced from the light source such that a rear surface of the light guide part that contacts the reflection part is depressed toward the front of the light guide part, and the reflection part is curved to contact the rear of the light guide part.
